(19) United States
(12) Patent Application Publication
(10) Pub. No.: US 2025/0244077 A1
(43) Pub. Date: Jul. 31, 2025

(54) REFRACTORY LAYER STRUCTURES AND ASSEMBLIES FOR VESSELS EXPOSED TO MOLTEN MATERIALS

(71) Applicant: HarbisonWalker International Holdings, Inc., Moon Township, PA (US)

(72) Inventors: Corey Forster, Carnegie, PA (US); Tomas Richter, Wexford, PA (US); Thomas S. Williams, Gibsonia, PA (US); Bryn Christine Snow, Bridgeville, PA (US)

(73) Assignee: HarbisonWalker International Holdings, Inc., Moon Township, PA (US)

(21) Appl. No.: 18/423,397

(22) Filed: Jan. 26, 2024

(51) Int. Cl. F27B 3/14; B22D 41/02; F27D 1/00

(52) U.S. Cl. CPC F27B 3/14; B22D 41/02; F27D 1/0006

(57) ABSTRACT

A refractory layer structure includes a layer of refractory blocks locked by each other in a tessellated pattern.

### FIELD OF THE INVENTION

The present invention relates generally to vessels exposed to molten materials, and, more specifically, to refractory layer structures and assemblies incorporated into such vessels for protection from the molten materials.

### BACKGROUND OF THE INVENTION

Several different types of vessels have been developed to handle molten material. Examples of such vessels include steel ladles, iron ladles, electric arc furnaces, quick basic oxygen furnaces, and glass tanks. Layers of refractory materials are installed to protect the bottoms of these vessels from the molten material.

It is typical that the bottom of such vessels are constructed out of at least one layer of safety lining and at least one layer of working lining. The individual layers may be constructed from preformed refractory shapes, such as brick or precast shapes, or can be formed in place from a monolithic refractory, such as a refractory castable or dry vibratable. The smaller brick shapes have rectangular geometries, and the larger precast shapes have conforming sizes to the geometry specific to the bottom of the vessels.

However, structural flaws leading to molten material leak and potential breach of the vessel are contemplated during vessel service with the above-referenced constructions. For example, the main reason for the incorporation of additional safety bottom layers in the bottoms of vessels is related to the formation of bottoms from standard brick shapes having many joints with straight paths, thereby having potential for traversal by molten material. The additional safety bottom layers act as the stopper layer collecting the liquid material and preventing vessel breach.

In addition, during thermal cycling that occurs during temperature variations in the bottom of the vessel, bricks could become loose during cooling, thereby resulting in the potential for upward float through the molten material during heating. Upward float is the result of a significant difference between the density of the refractory and density of the molten metal. For example, the density of the refractory is typically less than 200 lb/ft³ compared to 490 lb/ft³ for steel or 555 lb/ft³ for copper or around 700 lb/ft³ for lead. This floating is a safety concern, and a common issue for which a solution is desired. Floating can randomly occur if standard pressed shapes are improperly installed or possess geometrical design flaws.

Working layers that are constructed from large precast shapes or working layers that are cast in place are simpler than working layers constructed from bricks. Specifically, bricks frequently need to be joined in order to construct working layers. On the other hand, no joining is typically necessary for working layers that are constructed from large precast shapes or working layers that are cast in place. However, in order to construct working layers from large precast shapes or working layers that are cast in place, special equipment for material preparation, such as mixers and pumps, or material installation, such as cranes or lifters, is required. The large construction of such bottom layers can lead to the development of large thermally induced stresses on such layers, thereby leading to more frequent development of cracks and structural flaws during vessel service. These flaws could lead to molten material leak and potential breach of the vessel that are similarly experienced with brick construction.

Alternatively, dry materials that produce thin sintered solid layers during the initial exposure to heat and molten metal are used for the construction of the bottom working layers. The heat-induced creation of thin sintered solid layers on the top of the working layer composed from the dry material represents the only locking mechanism for dry material to stay in place after exposure to molten material. If such layers are not properly developed, the entirety of the monolithic dry material could float during service, likely resulting in catastrophic molten material breaches of the vessel.

The invention is designed to address these conventional drawbacks.

### SUMMARY OF THE INVENTION

In an example embodiment of the invention, a refractory layer structure includes a layer of refractory blocks locked by each other in a tessellated pattern.

In another example embodiment of the invention, a refractory vessel for holding materials includes a metal shell, a bottom safety lining, a refractory side wall, a refractory layer structure, and a refractory outer ring assembly. The bottom safety lining is positioned on an inner bottom surface of the metal shell. The refractory side wall is positioned on the bottom safety lining and an inner side surface of the metal shell. The refractory layer structure includes a layer of refractory blocks locked by each other in a tessellated pattern and positioned on the bottom safety lining. The refractory outer ring assembly is positioned in a space on the bottom safety lining between the refractory side wall and the refractory layer structure. The molten materials are held in an area defined by the refractory side wall, the refractory layer structure, and the refractory outer ring assembly.

In yet another example embodiment of the invention, a furnace for holding molten materials includes a metal shell, a refractory layer structure, and one or more tuyeres. The metal shell has a side wall and a bottom wall. The bottom wall has a removable center portion and an outer flange portion positioned between the side wall and the removable center portion. The refractory layer structure is positioned inside the metal shell on the removable center portion of the bottom wall. The refractory layer structure includes a plurality of layers of refractory blocks stacked on the removable center portion of the bottom wall. The refractory blocks of each of the layers are locked in a tessellated pattern. Each of the layers of locked refractory blocks include first block structures and second block structures. The first block structures widen from a lower portion thereof to an upper portion thereof. The second block structures narrow from a lower portion thereof to an upper portion thereof. The first block structures and the second block structures are respectively arranged adjacent to and in contact with each other in the tessellated pattern. Each of the layers of locked refractory blocks includes one or more holes formed therein. Each of the holes is defined by two of the first block structures and two of the second block structures of a respective one of the layers of locked refractory blocks. Each of the holes in each of the layers of locked refractory blocks corresponds with one of the holes in each of the layers of locked refractory blocks. The tuyeres extend through the corresponding ones of the holes in each of the stacked layers of locked refractory blocks.

The present invention provides a refractory layer in which the arrangement of the refractory blocks in a tessellated pattern inhibits floating of the refractory blocks.

The present invention further provides a refractory layer in which the arrangement of the refractory blocks in a tessellated pattern results in improved dissipation of thermally-induced stresses within environments to which the layer is exposed, as the thermally-induced stresses are deflected and divided via the angles or curvatures of the blocks constituting the tessellated pattern, as compressive or tensile stresses are better distributed or less concentrated in shapes with non-perpendicular angles or shaped having curvatures.

The present invention additionally provides a refractory layer in which the constructions of the refractory blocks arranged in a tessellated pattern would combine benefits of easily installed monolithic working refractory layers with performance inherent in standard refractory block layers.

The present invention also provides a metallurgical vessel for handling molten material and a furnace for handling molten material with the benefits of the refractory layers described above.

These and other advantages will become apparent from the following description of a preferred embodiment taken together with the accompanying drawings and claims.

### BRIEF DESCRIPTION OF THE DRAWINGS

The invention may take physical form in certain parts and arrangement of parts, a preferred embodiment of which will be described in detail in the specification and illustrated in the accompanying drawings which form a part hereof, and wherein:

FIG. 1 is a perspective view illustrating an example of a refractory layer structure according to an embodiment of the invention;

FIG. 2 is a perspective view illustrating another example of a refractory layer structure according to an embodiment of the invention;

FIG. 3 is a perspective view illustrating another example of a refractory layer structure according to an embodiment of the invention;

FIG. 4 is a perspective view illustrating a first example of a pattern of refractory blocks of the refractory layer structure according to an embodiment of the invention;

FIG. 5 is a perspective view illustrating a second example of a pattern of refractory blocks of the refractory layer structure according to an embodiment of the invention;

FIG. 6 is another perspective view illustrating a second example of a pattern of refractory blocks of the refractory layer structure according to an embodiment of the invention;

FIG. 7 is a perspective view illustrating a third example of a pattern of refractory blocks of the refractory layer structure according to an embodiment of the invention;

FIG. 8 is another perspective view illustrating a third example of a pattern of refractory blocks of the refractory layer structure according to an embodiment of the invention;

FIG. 9 is a perspective view illustrating an example of a layer of refractory blocks of a refractory layer structure for a furnace according to an embodiment of the invention;

FIG. 10 is a perspective view illustrating an example of a pattern of refractory blocks of a refractory layer structure for a furnace according to an embodiment of the invention;

FIG. 11 is another perspective view illustrating an example of a pattern of refractory blocks of a refractory layer structure for a furnace according to an embodiment of the invention;

FIG. 12 is a sectional side view of section 12-12 of FIG. 13 illustrating an example of a refractory vessel in which a refractory layer structure according to an embodiment of the invention is inserted;

FIG. 13 is a plan view illustrating an example of a refractory vessel in which a refractory layer structure according to an embodiment of the invention is inserted; and

FIG. 14 is a sectional side view illustrating an example of a basic oxygen furnace in which a refractory layer structure for a furnace according to an embodiment of the invention is inserted.

### DETAILED DESCRIPTION OF THE INVENTION

Referring now to the drawings, wherein the showing is for illustrating a preferred embodiment of the invention only and not for limiting same, various embodiments of the invention will be described.

For purposes of this description, a tessellated pattern is defined as an occurrence when geometric shapes having angles or curvatures in contact with each other repeat themselves to fully cover a three-dimensional layer structure without any gaps or overlaps.

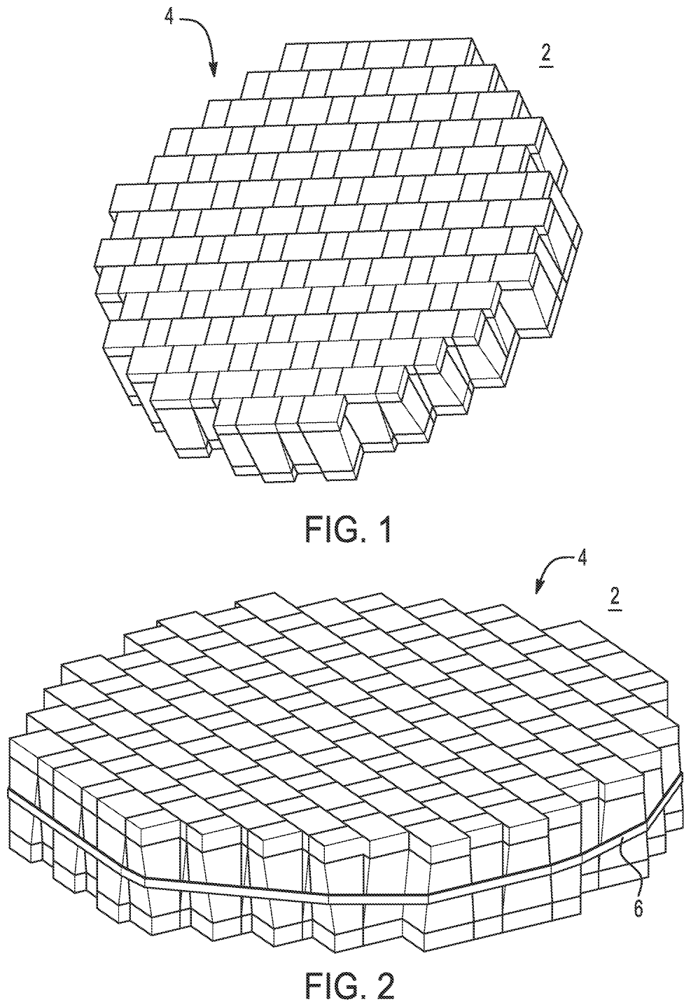

FIGS. 1-8 are perspective views illustrating examples of refractory layer structure 2 according to an embodiment of the invention. In FIGS. 1-3, refractory layer structure 2 includes layer 4 of refractory blocks 10 and 12, which are locked to each other in a tessellated pattern. Refractory blocks 10 and 12 are positioned in first tessellated refractory block pattern 8, which is illustrated in FIG. 4 and discussed in greater detail below. Refractory blocks 10 and 12 may be composed of various combinations of magnesia, carbon, and alumina and formed by hydraulic or isostatic pressing. The corresponding refractories are also known to be categorized as Magnesia-Carbon, Alumina-Magnesia-Carbon or Magnesia-Alumina-Carbon products.

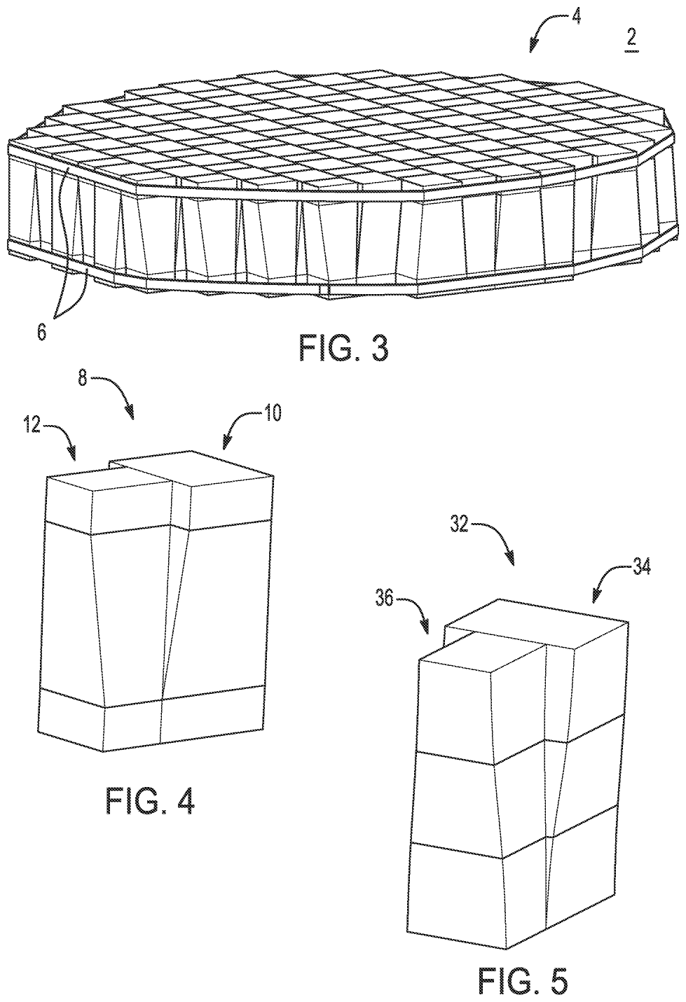

Locked refractory blocks 10 and 12 may be bound to each other in the tessellated pattern by a binder. The binder used may include, but is not limited to, one or more of organic, phosphate, or heat-setting glues or mortars. As is illustrated in FIGS. 2 and 3, locked refractory blocks 10 and 12 may also be secured to each other in the tessellated pattern by one or more securing bands 6. Securing bands 6 may be positioned around a circumference of layer 4 of locked refractory blocks 10 and 12 to secure locked refractory blocks 10 and 12 in the tessellated pattern. Securing bands 6 may be fabricated with steel or heavy-duty polypropylene or polyester plastic, but are not limited thereto. Securing bands 6 may also be used in conjunction with a binder to secure and bind locked refractory blocks 10 and 12 in the tessellated pattern.

Further, as illustrated in FIGS. 2 and 3, more than one of securing bands 6 may be used as the situation requires depending on the overall length of locked refractory blocks 10 and 12 and the surface area of layer 4 of locked refractory blocks 10 and 12. In one example, more than one of securing bands 6 could be required when locked refractory blocks 10 and 12 have an overall length that is greater than nine inches. In another example, if layer 4 of locked refractory blocks 10 and 12 were to have a surface area of 25 ft² or less, multiple securing bands 6 may not be required. However, if layer 4 of locked refractory blocks 10 and 12 were to have a surface area of between 25 ft² and 49 ft², two securing bands 6 may be required. Further, if layer 4 of locked refractory blocks 10 and 12 were to have a surface area of 49 ft² or greater, multiple securing bands 6 may be required.

As is illustrated in FIG. 4, refractory blocks 10 are first block structures that widen from a lower portion thereof to an upper portion thereof, i.e. the bottom thereof to the top thereof. Refractory blocks 12 are second block structures that narrow from a lower portion thereof to an upper portion thereof, i.e. the bottom thereof to the top thereof. Refractory blocks 10 and 12 are respectively arranged adjacent to and in contact with each other such that layer 4 of locked refractory blocks 10 and 12 is uninterrupted. Refractory blocks 10 and 12 have respective angles or curvatures that oppositely correspond with each other. Each of refractory blocks 10 and each of refractory blocks 12 is in contact with one or more adjacent refractory blocks 10.

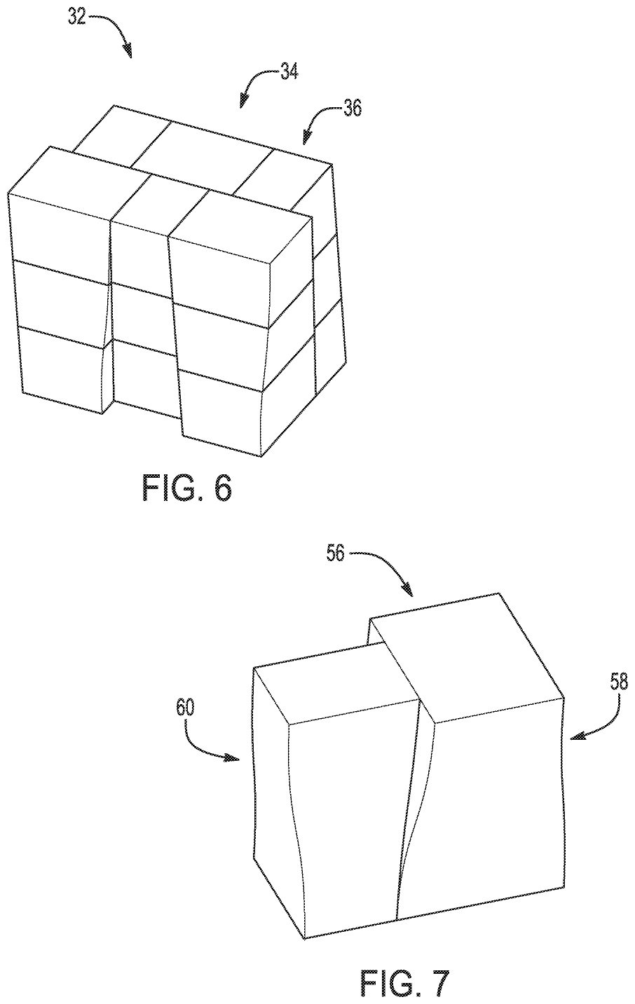

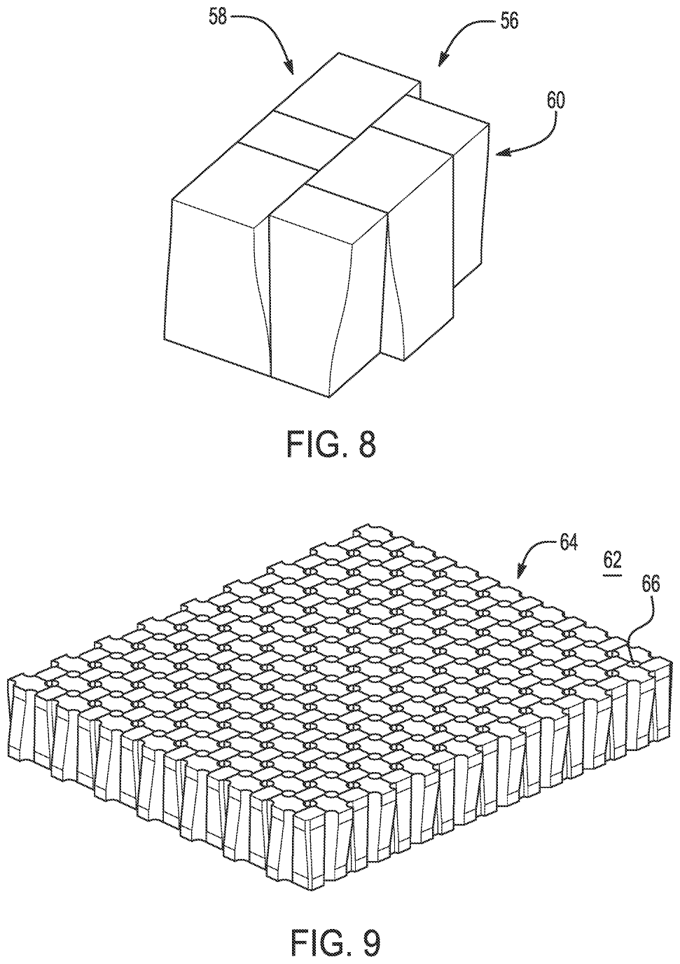

While first tessellated refractory block pattern 8 with locked refractory blocks 10 and 12 are shown to constitute layer 4 as illustrated in FIGS. 1-3, embodiments described herein are not limited thereto. FIGS. 5 and 6 illustrate second tessellated refractory block pattern 32 with locked refractory blocks 34 and 36. FIGS. 7 and 8 illustrate third tessellated refractory block pattern 56 with locked refractory blocks 58 and 60. Second tessellated refractory block pattern 32 and third tessellated refractory block pattern 56 may be used in place of first tessellated block pattern 8 depending on the needs of the application.

As illustrated in FIGS. 5 and 6, refractory blocks 34 are first block structures that widen from a lower portion thereof to an upper portion thereof, i.e. the bottom thereof to the top thereof. Refractory blocks 36 are second block structures that narrow from a lower portion thereof to an upper portion thereof, i.e. the bottom thereof to the top thereof. Refractory blocks 34 and 36 are respectively arranged adjacent to and in contact with each other such that layer 4 of locked refractory blocks 34 and 36 would be uninterrupted if constructed according to second tessellated refractory block pattern 32. Refractory blocks 34 and 36 have respective angles that oppositely correspond with each other. Each of refractory blocks 34 and each of refractory blocks 36 is in contact with one or more adjacent refractory blocks 34.

As illustrated in FIGS. 7 and 8, refractory blocks 58 are first block structures. Refractory blocks 60 are second block structures. Refractory blocks 58 and 60 are respectively arranged adjacent to and in contact with each other such that layer 4 of locked refractory blocks 58 and 60 would be uninterrupted if constructed according to second tessellated refractory block pattern 56. Refractory blocks 58 and 60 have curvatures that oppositely correspond with each other. Each of refractory blocks 58 and each of refractory blocks 60 is in contact with one or more adjacent refractory blocks 58.

Further, it is contemplated that any two designs of refractory blocks may be used as a tessellated refractory block pattern for layer 4 as long as the refractory blocks of layer 4 are locked in a tessellated pattern. Specifically, any two blocks, whether it be refractory blocks 10 and 12, refractory blocks 34 and 36, or refractory blocks 58 and 60, must complement each other geometrically to build layer 4 without gaps or overlaps. The angled or curved sides of refractory blocks 10 and 12, refractory blocks 34 and 36, and refractory blocks 58 and 60 serve to interrupt a direct path for penetration of molten materials and distribute expansion stresses from the molten materials more evenly throughout layer 4. The exact geometry of a tessellated pattern may be determined based on the overall stress anticipated or calculated for layer 4 in a specific application.

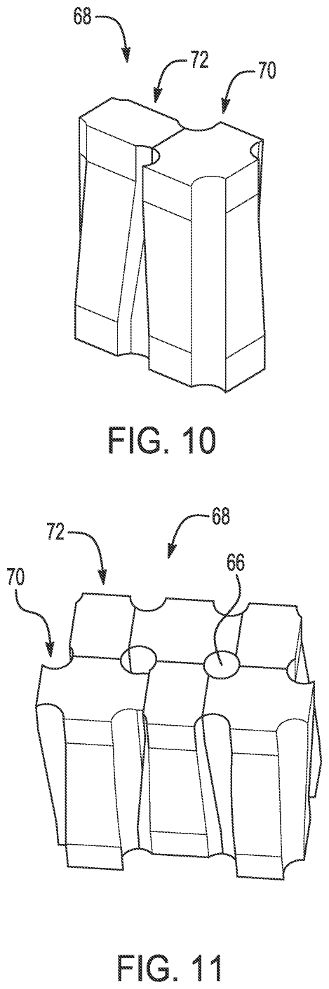

FIGS. 9-11 are perspective views illustrating examples of furnace refractory layer structure 62 according to an embodiment of the invention. Furnace refractory layer structure 62 includes layer 64 of refractory blocks 70 and 72, which are locked to each other in a tessellated pattern. Locked refractory blocks 70 and 72 are positioned in furnace tessellated refractory block pattern 68, which is illustrated in FIGS. 10 and 11 and discussed in greater detail below.

Locked blocks 70 and 72 may be bound to each other in the tessellated pattern by a binder. The binder used may include, but is not limited to, one or more of organic, phosphate, or heat-setting glues or mortars. While not illustrated herein, locked refractory blocks 70 and 72 may also be secured to each other in the tessellated pattern by one or more securing bands 6. Securing bands 6 may be positioned around a circumference of layer 64 of locked refractory blocks 70 and 72 to secure locked refractory blocks 70 and 72 in the tessellated pattern. Securing bands 6 may be fabricated with steel or heavy-duty polypropylene or polyester plastic, but are not limited thereto. Securing band 6 may also be used in conjunction with a binder to secure and bind locked refractory blocks 70 and 72 in the tessellated pattern.

Further, similar to the illustration of securing bands 6 in FIGS. 2 and 3, more than one of securing bands 6 may be used as the situation requires depending on the overall length of locked refractory blocks 70 and 72 and the surface area of layer 64 of locked refractory blocks 70 and 72. Locked refractory blocks 70 and 72 may have an overall length of up to 37 inches long, and thus would require securing by multiple securing bands 6. In another example, if layer 64 of locked refractory blocks 70 and 72 were to have a surface area of 25 ft² or less, multiple securing bands 6 may not be required. However, if layer 4 of locked refractory blocks 10 and 12 were to have a surface area of between 25 ft² and 49 ft², two securing bands 6 may be required. Further, if layer 4 of locked refractory blocks 10 and 12 were to have a surface area of 49 ft² or greater, multiple securing bands 6 may be required.

As is illustrated in FIGS. 10 and 11, refractory blocks 70 are first block structures that widen from a lower portion thereof to an upper portion thereof, i.e. the bottom thereof to the top thereof. Refractory blocks 72 are second block structures that narrow from a lower portion thereof to an upper portion thereof, i.e. the bottom thereof to the top thereof. Refractory blocks 70 and 72 are respectively arranged adjacent to and in contact with each other. Refractory blocks 70 and 72 have respective angles that oppositely correspond with each other, but, similar in concept to the subject matter illustrated in FIG. 7, could be designed with respective curvatures that oppositely correspond with each other. Each of refractory blocks 70 and each of refractory blocks 72 is in contact with one or more adjacent refractory blocks 70.

As is illustrated on FIGS. 9-11, layer 64 of locked refractory blocks 70 and 72 additionally includes one or more holes 66 formed therein. Each of holes 66 are defined by two of refractory blocks 70 and two of refractory blocks 72. Holes 66 are formed perpendicular to a top side and a bottom side of locked refractory blocks 70 and 72.

It is noted that, even though furnace refractory layer structure 62 is illustrated in FIG. 9 as including only layer 64 of locked refractory blocks 70 and 72, it is contemplated for furnace refractory layer structure 62 to include a number of stacked layers 64 of locked refractory blocks 70 and 72. This is shown with respect to basic oxygen furnace 108 illustrated in FIG. 14 and discussed further below with reference to FIG. 14. Further, while furnace refractory layer structure 62 as illustrated in FIG. 9 as a rectangular assembly, embodiments disclosure herein are not limited thereto, as furnace refractory layer structure 62 may have any other geometrical configuration. For example, a cylindrical assembly of furnace refractory layer structure 62 would be more likely with respect to basic oxygen furnace 108 illustrated in FIG. 14.

It is further noted that, even though furnace refractory layer structure 62 possesses furnace tessellated refractory block pattern 68 as illustrated in FIGS. 9-11, pattern 68 is one of many contemplated patterns, and embodiments described herein are not limited thereto. For example, furnace tessellated refractory block pattern 68 may be any pattern of refractory blocks allowing for both tessellation of the refractory blocks and holes to be included within the layer of refractory blocks.

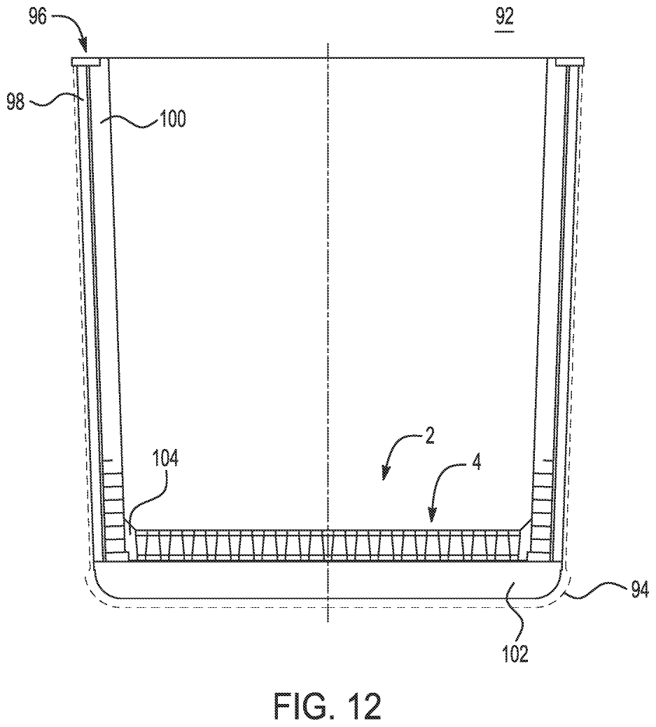

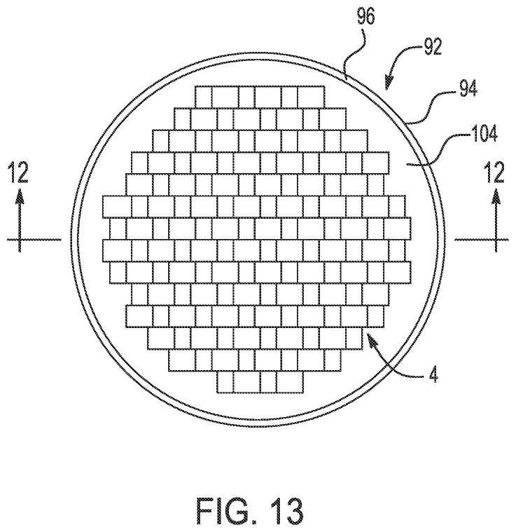

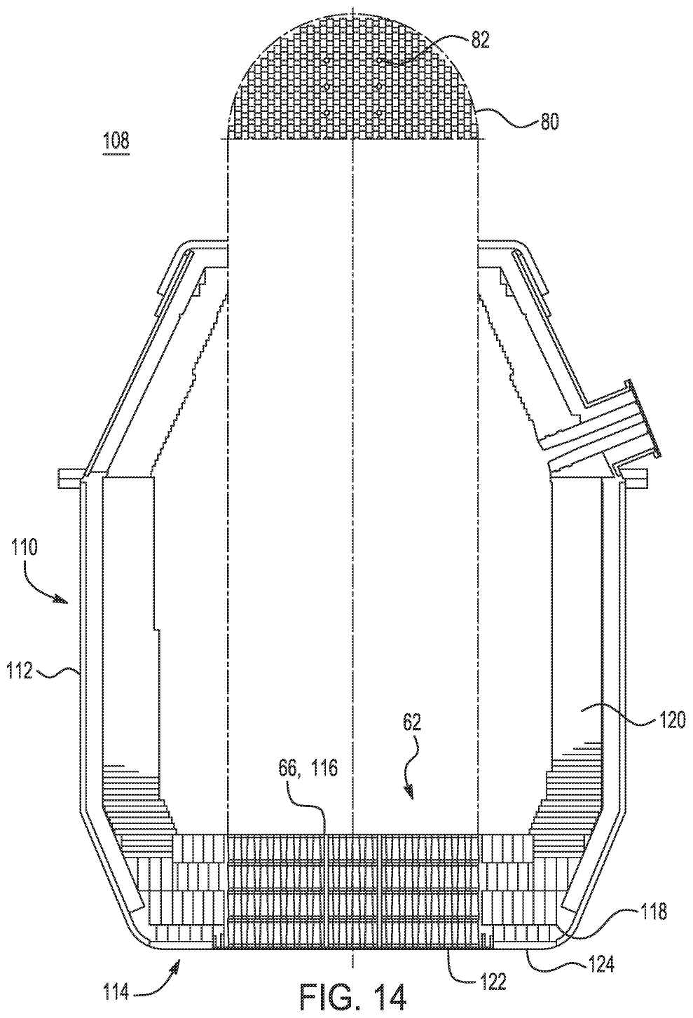

FIGS. 12 and 13 illustrate an example of refractory vessel 92 for holding molten materials. Refractory vessel 92 includes metal shell 94, bottom safety lining 102, refractory side wall 96, refractory layer structure 2, and refractory outer ring assembly 104. The molten materials are held in an area of refractory vessel 92 defined by refractory side wall 96, refractory layer structure 2, and refractory outer ring assembly 104.

Metal shell 94 defines an outer frame of refractory vessel 92. Bottom safety lining 102 is positioned on an inner bottom surface of metal shell 94. Bottom safety lining 102 is constituted of refractory materials in order to prevent damage to the bottom of metal shell 94 by molten materials being held in refractory vessel 92. Refractory side wall 96 is positioned on bottom safety lining 102 and an inner side surface of metal shell 94. Refractory side wall 96 includes wall safety lining 98 and working lining 100. Both wall safety lining 98 and working lining 100 are made of refractory materials to prevent damage to the inner side surface of metal shell 94. Working lining 100 may be constructed from refractory blocks or bricks.

For purposes of example, refractory layer structure 2 is illustrated as corresponding with layer 4 of locked refractory blocks 10 and 12 of first tessellated refractory block pattern 8. As such, locked refractory bricks 10 and 12 possess all features and elements previously disclosed with respect to first tessellated refractory block pattern 8 in FIGS. 1-4. However, as previously noted, layer 4 may include locked refractory blocks 34 and 36 of second tessellated refractory block pattern 32 or locked refractory blocks 58 and 60 of third tessellated refractory block pattern 56 instead of locked refractory blocks 10 and 12 of first tessellated refractory block pattern 8. Further, it is contemplated that any two designs of refractory blocks may be used as a tessellated refractory block pattern for layer 4 as long as the refractory blocks of layer 4 are locked in a tessellated pattern. Moreover, if used in place of first tessellated refractory block pattern 8, locked refractory blocks 34 and 36 and locked refractory blocks 58 and 60 respectively possess all features and elements previously disclosed with respect to second tessellated refractory block pattern 32 in FIGS. 5 and 6 and third tessellated refractory block pattern 56 in FIGS. 7 and 8.

Refractory outer ring assembly 104 is positioned in a space on bottom safety lining 102 between refractory side wall 96 and refractory layer structure 2. Refractory outer ring assembly 104 may be a cast refractory shape, a monolithic refractory, or constructed from refractory brick, and, as such, includes refractory materials. Refractory outer ring assembly 104 may be in contact with refractory layer structure 2. Further, while it has been previously discussed that locked refractory blocks 10 and 12 may be respectively bound or secured to each other in a tessellated pattern by a binder or one or more securing bands 6, refractory outer ring assembly 104 may contact refractory layer structure 2, serve to hold locked refractory blocks 10 and 12 in the tessellated pattern, and serve to hold refractory layer structure 2 within refractory vessel 92 to inhibit formation of voids that could allow pathways of molten material to form. It is also contemplated that refractory outer ring assembly 104 may perform the holding of locked refractory blocks 10 and 12 along with the respective binding or securing of locked refractory blocks 10 and 12 performed by a binder or one or more securing bands 6.

In one example of constructing refractory vessel 92, refractory layer structure 2 is formed before being positioned in refractory vessel 92. The forming of refractory layer structure 2 includes locking of refractory blocks 10 and 12 in a tessellated pattern. Locking of refractory blocks 10 and 12 outside of refractory vessel 92 is achieved by application of a binder or one or more securing bands 6. Then, formed refractory layer structure 2 is positioned on bottom safety lining 102 such that refractory outer ring assembly 104 is positioned in the space between refractory side wall 96 and layer 4 of locked refractory blocks 10 and 12. When refractory outer ring assembly 104 is positioned between refractory side wall 96 and layer of locked refractory blocks 10 and 12, refractory outer ring assembly 104 may also hold locked refractory blocks 10 and 12 in the tessellated pattern to hold formed refractory layer structure 2 within refractory vessel 92 to inhibit formation of voids that could allow pathways of molten material to form.

In another example of constructing refractory vessel 92, refractory layer structure 2 is formed on bottom safety lining 102. Specifically, layer 4 of locked refractory blocks 10 and 12 is assembled on bottom safety lining 102. The assembling of layer 4 includes arranging refractory blocks 10 and 12 in a tessellated pattern. Refractory outer ring assembly 104 is then positioned on a space on bottom safety lining 102 between refractory side wall 96 and formed refractory layer structure 4.

Arranged refractory blocks 10 and 12 are locked in the tessellated pattern, and locked refractory blocks 10 and 12 may be held in the tessellated pattern by the positioning of refractory outer ring assembly 104, application of a binder, or use of one or more securing bands 6. It is contemplated that one or more of the aforementioned means may be used simultaneously.

FIG. 14 illustrates an example of basic oxygen furnace 108 for holding molten materials. Basic oxygen furnace 108 includes metal shell 110, furnace refractory layer structure 62, and one or more tuyeres 116. Metal shell 110 includes side wall 112 and bottom wall 114. Bottom wall 114 has removable center portion 122 and outer flange portion 124 positioned between side wall 112 and removable center portion 122.

Furnace refractory layer structure 62 is positioned inside metal shell 110 on removable center portion 122 of bottom wall 114. Furnace refractory layer structure 62 includes a number of layers 64 of locked refractory blocks 70 and 72 stacked on removable center portion 122 of bottom wall 114. Refractory blocks 70 and 72 of each of layers 64 are locked in a tessellated pattern. The respective binding, securing, or holding of locked refractory blocks 70 and 72 of each of layers 64 is achieved through a binder, one or more securing bands 6 positioned around the circumference each of layers 64, or refractory outer ring assembly 118 (discussed in greater detail below).

As was previously illustrated in FIGS. 10 and 11, refractory blocks 70 are first block structures that widen from a lower portion thereof to an upper portion thereof, i.e. the bottom thereof to the top thereof. Refractory blocks 72 are second block structures that narrow from a lower portion thereof to an upper portion thereof, i.e. the bottom thereof to the top thereof. Refractory blocks 70 and 72 in each of layers 64 are respectively arranged adjacent to and in contact with each other such that refractory blocks 70 and 72 are locked in a tessellated pattern.

It is again noted that, even though furnace refractory layer structure 62 possesses furnace tessellated refractory block pattern 68 as illustrated in FIGS. 9-11, pattern 68 is one of many contemplated patterns, and embodiments described herein are not limited thereto. For example, furnace tessellated refractory block pattern 68 may be any pattern of refractory blocks allowing for both tessellation of the refractory blocks and holes to be included within the layer of refractory blocks.

As was previously discussed with respect to FIGS. 9-11, each of layers 64 of locked refractory blocks 70 and 72 additionally includes one or more holes 66 formed therein. Each of holes 66 are defined by two of refractory blocks 70 and two of refractory blocks 72 in each of layers 64. As is illustrated in FIG. 14, each of holes 66 in each of layers 64 correspond with each other, i.e. one of holes 66 in each of layers 64 of locked refractory blocks 70 and 72. Each of layers 64 correspond with each other.

Tuyeres 116 respectively extend through each of the corresponding holes 66 in each of the stacked layers 64 of locked refractory blocks 70 and 72. Tuyeres 116 provide oxygen so that basic oxygen furnace 108 can be used to heat molten material placed therein.

Basic oxygen furnace 108 also may include refractory outer ring assembly 118 positioned on bottom wall 114 of metal shell 110 between furnace refractory layer structure 62 and side wall 112 of metal shell 110. In addition, basic oxygen furnace 108 may include refractory side wall 120 positioned on refractory outer ring assembly 118 and lining side wall 112 of metal shell 110. The molten materials may be held in an area defined by refractory side wall 120, furnace refractory layer structure 62, and refractory outer ring assembly 118.

In one example of constructing basic oxygen furnace 108, metal shell 110 is provided with side wall 112 and bottom wall 114. As previously mentioned, bottom wall 114 has removable center portion 122 and outer flange portion 124 positioned between side wall 112 and removable center portion 122. Furnace refractory layer structure 62 is positioned on removable center portion 122 of bottom wall 114 when removable center portion 122 is separated from metal shell 110. In other words, furnace refractory layer structure 62 is positioned on removable center portion 122 outside of metal shell 110 when is furnace refractory layer structure 62 is not attached to outer flange portion 124.

The positioning of furnace refractory layer structure 62 includes a stacking of a plurality of layers 64 of locked refractory blocks 70 and 72 on removable center portion in a tessellated pattern. The specific constitution of layers 64 of locked refractory blocks 70 and 72, including holes 66, is the same as discussed above. Respective binding, securing, or holding of locked refractory blocks 70 and 72 is as previously discussed with a binder, one or more securing bands 6, or refractory outer ring assembly 188. After the positioning of furnace refractory layer structure 62, one or more tuyeres 116 are extended through previously discussed corresponding holes 66 in each of the stacked layers 64 of locked refractory blocks 70 and 72. After the extending of the tuyeres 116, removable center portion 122, on which furnace refractory layer structure 62 is positioned, is attached to outer flange portion 124 such that furnace refractory layer structure 62 is surrounded by side wall 112 of metal shell 110.

The foregoing descriptions regard specific embodiments of the present invention. It should be appreciated that this embodiment is described for purposes of illustration only, and that numerous alterations and modifications may be practiced by those skilled in the art without departing from the spirit and scope of the invention. It is intended that all such modifications and alterations be included insofar as they come within the scope of the invention as claimed or the equivalents thereof.

What is claimed is:

1. A refractory layer structure, comprising:
a layer of refractory blocks locked by each other in a tessellated pattern.

2. The structure according to claim 1, further comprising:
a binder applied between the locked refractory blocks to bind the locked refractory blocks in the tessellated pattern.

3. The structure according to claim 1, further comprising:
one or more securing bands positioned around a circumference of the layer of locked refractory blocks to secure the locked refractory blocks in the tessellated pattern.

4. The structure according to claim 1, wherein the layer of locked refractory blocks is uninterrupted.

5. The structure according to claim 1, wherein each of the refractory blocks have angles or curvatures that respectively oppositely correspond with angles or curvatures of adjacent ones of the refractory blocks.

6. The structure according to claim 1, wherein the layer of locked refractory blocks comprises:
first block structures that widen from a lower portion thereof to an upper portion thereof; and
second block structures that narrow from a lower portion thereof to an upper portion thereof,
wherein the first block structures and the second block structures are respectively arranged adjacent to and in contact with each other in the tessellated pattern.

7. The structure according to claim 6, wherein each of the first block structures is in contact with one or more adjacent ones of the first block structures.

8. The structure according to claim 1, wherein the layer of locked refractory blocks comprises first block structures and second block structures, the first block structures and the second block structures being respectively arranged adjacent to and in contact with each other in the tessellated pattern, each of the refractory blocks having curvatures that respectively oppositely correspond with curvatures of adjacent ones of the refractory blocks.

9. The structure according to claim 6, wherein the layer of locked refractory blocks includes one or more holes formed therein, each of the holes being defined by two of the first block structures and two of the second block structures.

10. A refractory vessel for holding molten materials, the vessel comprising:
a metal shell;
a bottom safety lining positioned on an inner bottom surface of the metal shell;
a refractory side wall positioned on the bottom safety lining and an inner side surface of the metal shell;
a refractory layer structure comprising a layer of refractory blocks locked by each other in a tessellated pattern and positioned on the bottom safety lining; and
a refractory outer ring assembly positioned in a space on the bottom safety lining between the refractory side wall and the refractory layer structure,
wherein the molten materials are held in an area defined by the refractory side wall, the refractory layer structure, and the refractory outer ring assembly.

11. The vessel according to claim 10, wherein the refractory outer ring assembly is configured to contact the refractory layer structure and hold the locked refractory blocks in the tessellated pattern.

12. A furnace for holding molten materials, the furnace comprising:
a metal shell having a side wall and a bottom wall, the bottom wall having a removable center portion and an outer flange portion positioned between the side wall and the removable center portion;
a refractory layer structure positioned inside the metal shell on the removable center portion of the bottom wall, the refractory layer structure comprising a plurality of layers of refractory blocks stacked on the removable center portion of the bottom wall, the refractory blocks of each of the layers being locked in a tessellated pattern, each of the layers of locked refractory blocks comprising first block structures and second block structures, the first block structures widening from a lower portion thereof to an upper portion thereof, the second block structures narrowing from a lower portion thereof to an upper portion thereof, the first block structures and the second block structures being respectively arranged adjacent to and in contact with each other in the tessellated pattern, each of the layers of locked refractory blocks including one or more holes formed therein, each of the holes being defined by two of the first block structures and two of the second block structures of a respective one of the layers of locked refractory blocks, each of the holes in each of the layers of locked refractory blocks corresponding with one of the holes in each of the layers of locked refractory blocks; and
one or more tuyeres extending through the corresponding ones of the holes in each of the stacked layers of locked refractory blocks.

13. The furnace according to claim 12, further comprising:
a refractory outer ring assembly positioned on the bottom wall of the metal shell between the refractory layer structure and a side wall of the metal shell; and
a refractory side wall positioned on the refractory outer ring assembly and lining the side wall of the metal shell,
wherein the molten materials are held in an area defined by the refractory side wall, the refractory layer structure, and the refractory outer ring assembly.

14. The furnace according to claim 12, wherein the refractory outer ring assembly is configured to contact the refractory layer structure and hold the locked refractory blocks in the tessellated pattern.

15. The furnace according to claim 12, wherein the layers of locked refractory blocks correspond with each other.

16. The furnace according to claim 12, wherein the refractory layer structure further comprises one or more securing bands positioned around a circumference of each of the layers of locked refractory blocks to secure the locked refractory blocks in the tessellated pattern.
